(19) United States
(12) Patent Application Publication
(10) Pub. No.: US 2013/0036211 A1
(43) Pub. Date: Feb. 7, 2013

(54) Coordinated service to multiple mobile devices

(71) Applicants: Alan Messer, Los Gotos, CA (US); Kyoung-Lae Noh, Suwon City (KR)

(72) Inventors: Alan Messer, Los Gotos, CA (US); Kyoung-Lae Noh, Suwon City (KR)

(73) Assignee: Samsung Electronics Co., Ltd., Suwon City (KR)

(21) Appl. No.: 13/136,487

(22) Filed: Aug. 1, 2011

(51) Int. Cl. G06F 15/173

(52) U.S. Cl. 709/223

(57) ABSTRACT

In a first embodiment of the present invention, a method is provided comprising: receiving application data from a first application on the first device, wherein the application is designed to automatically send application data pertaining to a first service to the server; determining if the first device is a member of a collection group or a control group; when the first device is a member of a collection group, sending the application data to one or more other devices that are members of the collection group to allow the other members of the collection group to provide a version of the first service having unfiltered application data; and when the first device is a member of a control group, sending some, but not all, of the application data to particular one or more other devices that are members of the control group, based on a stored set of rules, to allow the other members of the control group to provide a version of the first service having filtered application data.

### BACKGROUND OF THE INVENTION

1. Field of the Invention

The present invention relates generally to consumer electronic devices. More specifically, the present invention relates to coordinated service to multiple mobile devices.

2. Description of the Related Art

Mobile devices, most particularly in the form of cellular phones, have become the prevalent mode of communication for many people. As these devices have become more powerful, the processing power and memory capabilities of these devices have allowed them to become closer to computers than phones. Such intelligent cellular phones are often called “smartphones.” More recently, tablet computers have become increasingly popular as well. These tablet computers may have access to cellular services via embedded 3G/4G antennas, or may access cellular services indirectly through a WiFi connection. However, rather than supplant the use of smartphones, what has occurred is that many users have both a smartphone and a tablet computer. This trend of having more and more “smart” devices within the control of a single user may become even stronger in the future.

While users may wish to utilize their smartphone as their first mode of electronic verbal communication, other non-verbal cellular communications, such as text messages, need not be so limited. Additionally, since most smartphones allow users to install other programs or services, such as games, social networking applications, mapping tools, etc. as well, it may be desirable for the user to be able to access those same programs and services on other devices as well. Indeed, as the number of mobile devices a particular user continues to increase, the need for such coordination will only increase.

### SUMMARY OF THE INVENTION

In a first embodiment of the present invention, a method is provided comprising: receiving application data from a first application on the first device, wherein the application is designed to automatically send application data pertaining to a first service to the server; determining if the first device is a member of a collection group or a control group; when the first device is a member of a collection group, sending the application data to one or more other devices that are members of the collection group to allow the other members of the collection group to provide a version of the first service having unfiltered application data; and when the first device is a member of a control group, sending some, but not all, of the application data to particular one or more other devices that are members of the control group, based on a stored set of rules, to allow the other members of the control group to provide a version of the first service having filtered application data.

In a second embodiment of the present invention, a method is provided comprising: receiving application data pertaining to a group of devices; determining if the group is a collection group or a control group; when the group is a collection group, sending the application data to one or more devices that are members of the collection group; and when the group if a control group, sending some, but not all, of the application data to particular one or more devices that are members of the control group, based on a stored set of rules.

In a third embodiment of the present invention, a server is provided comprising: a memory storing at least one collection group, wherein the collection group is a list having a plurality of members, and at least one control group, wherein the control group is a list having a plurality of members, wherein the member further includes a stored set of rules pertaining to the control group; one or more communications interfaces designed to communicate with each member of the collection group and/or control group; a processor configured to: receive application data from a first application on the first device, wherein the application is designed to automatically send application data pertaining to a first service to the server; determine if the first device is a member of a collection group or a control group; when the first device is a member of a collection group, send the application data to one or more other devices that are members of the collection group to allow the other members of the collection group to provide a version of the first service having unfiltered application data; and when the first device is a member of a control group, sending some, but not all, of the application data to particular one or more other devices that are members of the control group, based on a stored set of rules, to allow the other members of the control group to provide a version of the first service having filtered application data.

In a fourth embodiment of the present invention, a non-transitory program storage device readable by a machine tangibly embodying a program of instructions executable by the machine is provided to perform a method comprising: receiving application data from a first application on the first device, wherein the application is designed to automatically send application data pertaining to a first service to the server; determining if the first device is a member of a collection group or a control group; when the first device is a member of a collection group, sending the application data to one or more other devices that are members of the collection group to allow the other members of the collection group to provide a version of the first service having unfiltered application data; and when the first device is a member of a control group, sending some, but not all, of the application data to particular one or more other devices that are members of the control group, based on a stored set of rules, to allow the other members of the control group to provide a version of the first service having filtered application data.

In a fifth embodiment of the present invention, an apparatus is provided comprising: means for receiving application data from a first application on the first device, wherein the application is designed to automatically send application data pertaining to a first service to the server; means for determining if the first device is a member of a collection group or a control group; means for, when the first device is a member of a collection group, sending the application data to one or more other devices that are members of the collection group to allow the other members of the collection group to provide a version of the first service having unfiltered application data; and means for, when the first device is a member of a control group, sending some, but not all, of the application data to particular one or more other devices that are members of the control group, based on a stored set of rules, to allow the other members of the control group to provide a version of the first service having filtered application data.

### BRIEF DESCRIPTION OF THE DRAWINGS

FIG. 1 is a flow diagram illustrating a general method for coordinating service between multiple mobile devices in accordance with an embodiment of the present invention.

FIG. 2 is a flow diagram illustrating a method in accordance with an embodiment of the present invention.

FIG. 3 is a block diagram illustrating a system in accordance with an embodiment of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

In accordance with the present invention, the components, process steps, and/or data structures may be implemented using various types of operating systems, programming languages, computing platforms, computer programs, and/or general purpose machines. In addition, those of ordinary skill in the art will recognize that devices of a less general purpose nature, such as hardwired devices, field programmable gate arrays (FPGAs), application specific integrated circuits (ASICs), or the like, may also be used without departing from the scope and spirit of the inventive concepts disclosed herein. The present invention may also be tangibly embodied as a set of computer instructions stored on a computer readable medium, such as a memory device.

In an embodiment of the present invention, a server is provided that enables grouping and control of delivering one service to multiple devices. The replicated service can be a complete duplication of the original service, or be a lesser form of the original service obtained through filtering based on rules. The services may be delivered directly to each device through communication with a specialized server (known as a SIMergy server, described below. In this way, information can be shared multiple mobile devices in such a way that the multiple mobile devices can act together.

The user can designate one or more devices as “hubs” in the coordinated service. These devices provide the core settings and control of the entire device collection. For example, a parent's smartphone may contain the settings to control the entire family's devices. Alternatively, a user's “first” device may contain the settings to control other devices operated by the same user. Hubs may operate in two modes: collection or control. In collection mode, the settings and applications on the hub devices are automatically duplicated to other devices in the same group. For example, a user's social networking application on a smartphone can automatically duplicate its application data on a tablet computer. In control mode, the user's hub device provides control over the other devices in the group. The hub device may enforce policies across those devices as well as send messages to the collection of devices. For example, a parent may control a child's phone for access policies, as well as send a message to the entire family via the hub device.

The present invention may introduce the idea of a SIMergy server. A SIMergy server is a server designed to coordinate services and data between groups of personal devices. The SIMergy server can take many forms. In one embodiment of the present invention, the SIMergy server is a software program operating on a first device of a user's network. For example, the SIMergy server may operate on a laptop computer or tablet computer. However, in other embodiments of the present invention, the SIMergy server may operate on a separate device, such as a gateway, in a home network. In other embodiments, the SIMergy server may be controlled by a service provider.

In an embodiment of the present invention, a server system is provided for mobile devices that allows services to be delivered across the mobile devices. As described above, there are two types of service delivery in one embodiment of the present invention. A “collection of devices service” delivery provides for service delivery between devices such that each device receives the same service as others in the same policy group. A typical example may be an adult user having multiple mobile devices (e.g., smartphone, tablet, and watch). In this case, when a SIMergy service is delivered to the user it is sent to all the devices in the collection, since the user may be operating any one of the devices. As such, the delivery to each device is symmetric and equivalent in policy and access.

“Controlled devices” service delivery provides for service delivery between devices where one device is in control of how the service is delivered to the other devices. A typical example may be a parent controlling the delivery of a service to a child's mobile device. In this case, the service or policies may be directed to a particular controlled device. Such services may include messaging or family media sharing where parents control how media is shared to the family.

In addition to these roles, a grouping of devices may be identified and secured by leveraging the cellular infrastructure's ability to identify each device (using SIM card ID, for example). When a device is purchased or later acquired, the user communicates to the service providers through the SIMergy server. The SIMergy server can be integrated with the service provider's provisioning systems to identify the device being purchased/added and match that to a user. By doing so, the user does not need to associate the device into one of the service deployments because it is simply set at the time the equipment is purchased or added. By leveraging the cellular identification mechanisms, the SIMergy server can securely identify the devices in the service deployment. Once identified, traditional security mechanisms can be added to secure the channels used if necessary.

Together these roles allow services to be directed to users according to their role, such as in social grouping (family), to meet the needs of the users. By providing little or no setup requirements, along with security, trusted services can be deployed between devices without privacy and security concern associate with the Internet.

With the information that multiple devices are possibly under the ownership of a single user, presence information on these devices can be used to prioritize service delivery to those devices. For each device in the collection group, the SIMergy server can keep a copy of when the device was last used for physical interaction. For example, the last time the device was used for a call or accessing the network under user control can be tracked. The SIMergy service can then use this to notify each device of the visibility of changes. For example, the device can use this information to determine whether it should alert a user actively or passively of a new text message. For example, if a tablet has been used recently, the notification may appear on the display along with a vibration and tone, while a smartphone that hasn't been used for awhile will simply vibrate and update its home screen status page.

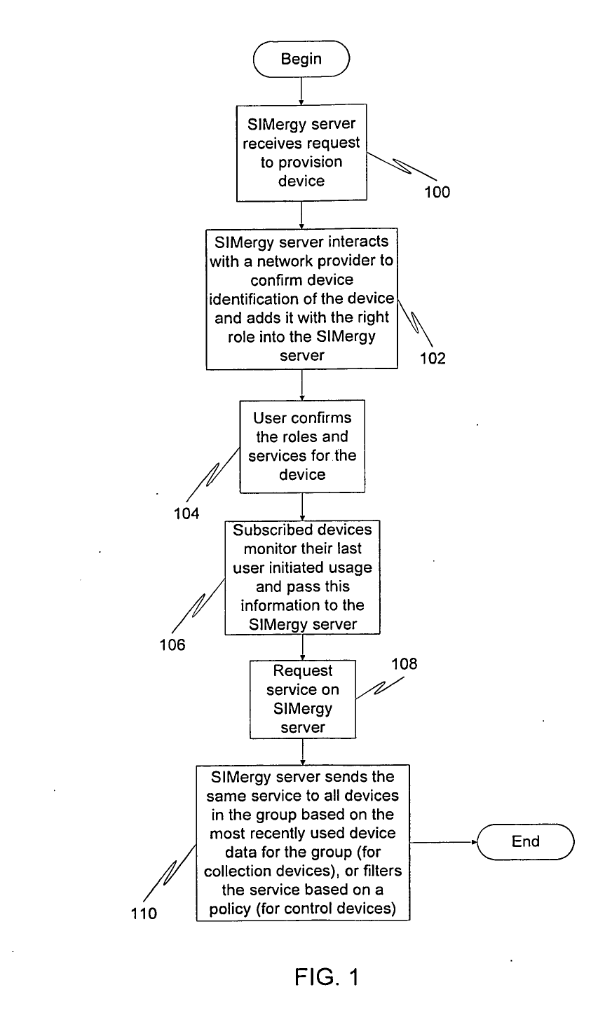

FIG. 1 is a flow diagram illustrating a general method for coordinating service between multiple mobile devices in accordance with an embodiment of the present invention. At 100, the SIMergy server receives a request to provision a device. At 102, the SIMergy server interacts with a network provider to confirm device identification of the device and adds it with the right role into the SIMergy server. At 104, the user confirms the roles and services for the device in question. The device is now subscribed into the SIMergy server. At 106, subscribed devices monitor their last user initiated usage and pass this information to the SIMergy server. The SIMergy server records this associates it with that device for all groups to which the device belongs.

At 108, a service is requested on the SIMergy server (e.g., social networking update, call, text message, group message to the family, secure family media sharing, etc.). At 110, depending on the service and the configuration of the devices, the SIMergy server may either send the same service to all the devices in the group with the urgency level based on the most recently used device data for the group (for collection devices), or filter the service based on a policy (for control devices).

In one example of the present invention, an application running on a smartphone may post a notification update to the notification system of the operating system of the smartphone. This displays to the user as normal, e.g., as a pull-down from the top of the screen, but the invention also obtains this notification to send the notification to a SIMergy server. That server may then have the device registered with it along with one or more other devices in a “collection group” where all devices want in the collection group want to receive the same information. The SIMergy server then forwards that notification on to the other devices.

The present invention may also provide interfaces for other communications with the other devices. For example, an interface may be provided to allow media (e.g., voicemail recordings) to be passed from the first device to the other device(s). Likewise, the other devices can return updates to the SIMergy service, which then passes these updates to the first device in the collection group. For example, the user may be able to acknowledge and dismiss a notification on one of the other devices and have the fact that the notification was dismissed passed back to the first device, so the same notification no longer appears on the first device.

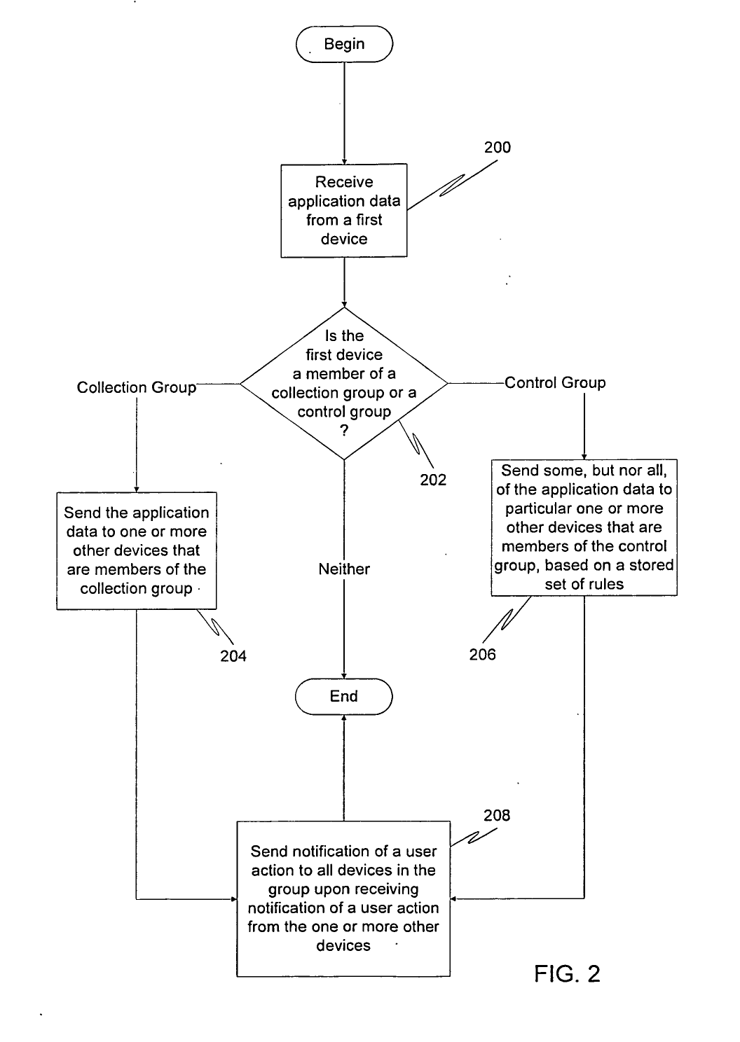

FIG. 2 is a flow diagram illustrating a method in accordance with an embodiment of the present invention. The steps of the method may be performed at a SIMergy or other similar server. At 200, application data may be received from a first device. At 202, it is determined if the first device is a member of a collection group or a control group (or neither). At 204, when the first device is a member of a collection group, the application data is sent to one or more other devices that are members of the collection group. In some embodiments, the sending of the application data when the first device is a member of a collection group is performed symmetrically and equivalently across all other devices that are members of the collection group. At 206, when the first device is a member of a control group, some, but not all, of the application data is sent to particular other devices that are members of a control group, based on a stored set of rules. The stored set of rules may be controlled by the first device. In other words, a user of a first device can modify the stored set of rules, but a user of another device in the group cannot.

At 208, upon receiving notification of a user action from the one or more other devices that was in response to the one or more other devices communicating the application data to a user, notification of the user action may be sent to all devices in the group.

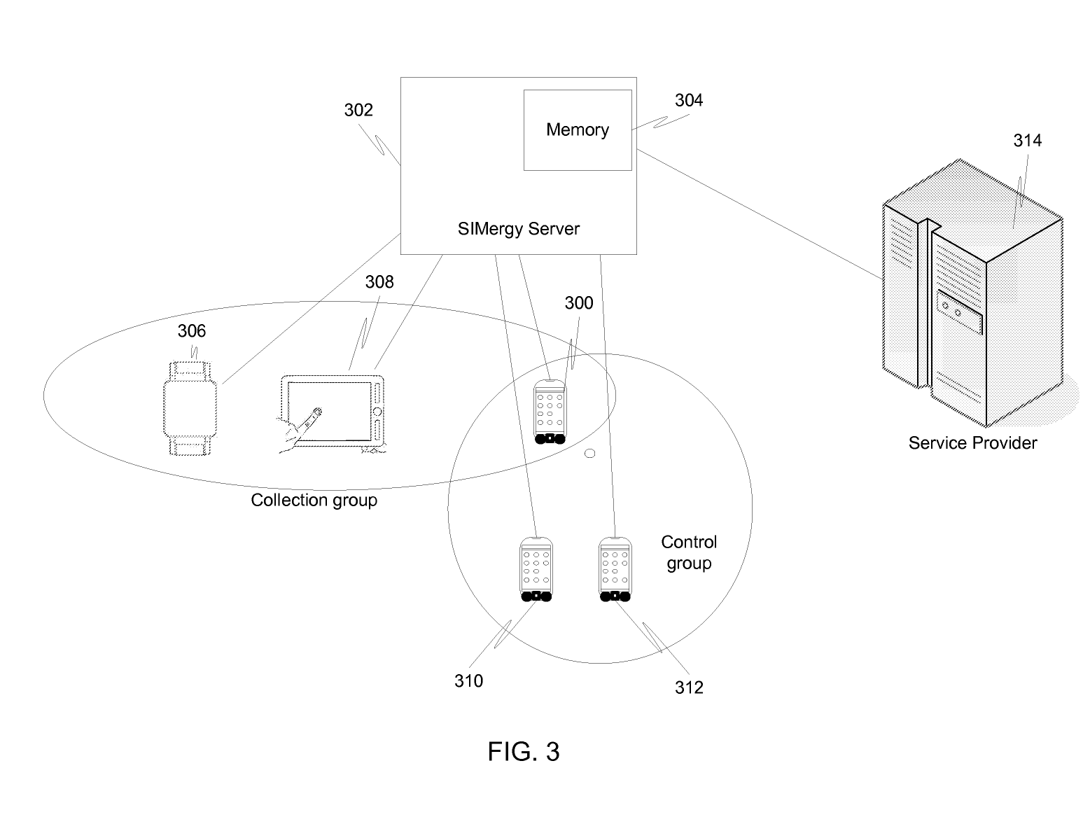

FIG. 3 is a block diagram illustrating a system in accordance with an embodiment of the present invention. A first device 300 contains an application or applications that transmit application data to SIMergy server 302. The SIMergy server 302 then accesses a memory 304 that contains information about collection groups and control groups. If the first device 300 is a member of a collection group, then other devices 306, 308 that are also members of the collection group receive the application data from the SIMergy server 302. If the first device is a member of a control group, then certain other devices 310, 312 that are also members of the control group may receive some of the application data, based on rules. It should be noted that embodiments are possible wherein the first device 300 is a member of more than one collection group or control group, in which case the application data may be replicated among the members of multiple collection groups or control groups at the same time.

As described above, in some embodiments, a service provider 314 may establish the collection and/or control groups when devices are purchased or provisioned.

As will be appreciated to one of ordinary skill in the art, the aforementioned example architectures can be implemented in many ways, such as program instructions for execution by a processor, as software modules, microcode, as computer program product on computer readable media, as logic circuits, as application specific integrated circuits, as firmware, as consumer electronic device, etc. and may utilize wireless devices, wireless transmitters/receivers, and other portions of wireless networks. Furthermore, embodiment of the disclosed method and system for displaying multimedia content on multiple electronic display screens can take the form of an entirely hardware embodiment, an entirely software embodiment, or an embodiment containing both software and hardware elements.

The term “computer readable medium” is used generally to refer to media such as main memory, secondary memory, removable storage, hard disks, flash memory, disk drive memory, CD-ROM and other forms of persistent memory. It should be noted that program storage devices, as may be used to describe storage devices containing executable computer code for operating various methods of the present invention, shall not be construed to cover transitory subject matter, such as carrier waves or signals. Program storage devices and computer readable medium are terms used generally to refer to media such as main memory, secondary memory, removable storage disks, hard disk drives, and other tangible storage devices or components.

Although only a few embodiments of the invention have been described in detail, it should be appreciated that the invention may be implemented in many other forms without departing from the spirit or scope of the invention. Therefore, the present embodiments should be considered illustrative and not restrictive and the invention is not to be limited to the details given herein, but may be modified within the scope and equivalents of the appended claims.

What is claimed is:

1. A method, performed at a server, comprising:
receiving application data from a first application on the first device, wherein the application is designed to automatically send application data pertaining to a first service to the server;
determining if the first device is a member of a collection group or a control group;
when the first device is a member of a collection group, sending the application data to one or more other devices that are members of the collection group to allow the other members of the collection group to provide a version of the first service having unfiltered application data; and
when the first device is a member of a control group, sending some, but not all, of the application data to particular one or more other devices that are members of the control group, based on a stored set of rules, to allow the other members of the control group to provide a version of the first service having filtered application data.

2. The method of claim 1, wherein the stored set of rules are controlled by the first device.

3. The method of claim 1, wherein the application data is a text message.

4. The method of claim 1, wherein the application data is calendar information.

5. The method of claim 1, wherein the sending of the application data when the first device is a member of a collection group is performed symmetrically and equivalently across all other devices that are members of the collection group.

6. The method of claim 1, wherein the collection group and the control group are established by a service provider upon activation of the first and/or other devices.

7. The method of claim 1, further comprising:
tracking when the other devices were last interacted with by a user; and
altering notification settings on one or more of the devices based upon the information regarding when the other devices were last interacted with by a user.

8. The method of claim 1, further comprising:
upon receiving notification of a user action from the one or more other devices that was in response to the one or more other devices communicating the application data to a user, sending notification of the user action to all devices in the collection group or control group.

9. A method comprising:
receiving application data pertaining to a group of devices;
determining if the group is a collection group or a control group;
when the group is a collection group, sending the application data to one or more devices that are members of the collection group; and
when the group if a control group, sending some, but not all, of the application data to particular one or more devices that are members of the control group, based on a stored set of rules.

10. A server comprising:
a memory storing at least one collection group, wherein the collection group is a list having a plurality of members, and at least one control group, wherein the control group is a list having a plurality of members, wherein the member further includes a stored set of rules pertaining to the control group;
one or more communications interfaces designed to communicate with each member of the collection group and/or control group;
a processor configured to:
receive application data from a first application on the first device, wherein the application is designed to automatically send application data pertaining to a first service to the server;
determine if the first device is a member of a collection group or a control group;
when the first device is a member of a collection group, send the application data to one or more other devices that are members of the collection group to allow the other members of the collection group to provide a version of the first service having unfiltered application data; and
when the first device is a member of a control group, sending some, but not all, of the application data to particular one or more other devices that are members of the Control group, based on a stored set of rules, to allow the other members of the control group to provide a version of the first service having filtered application data.

11. The server of claim 10, wherein the server is controlled by a service provider.

12. The server of claim 10, wherein the server is part of a home network.

13. A non-transitory program storage device readable by a machine tangibly embodying a program of instructions executable by the machine to perform a method comprising:
receiving application data from a first application on the first device, wherein the application is designed to automatically send application data pertaining to a first service to the server;
determining if the first device is a member of a collection group or a control group;
when the first device is a member of a collection group, sending the application data to one or more other devices that are members of the collection group to allow the other members of the collection group to provide a version of the first service having unfiltered application data; and
when the first device is a member of a control group, sending some, but not all, of the application data to particular one or more other devices that are members of the control group, based on a stored set of rules, to allow the other members of the control group to provide a version of the first service having filtered application data.

14. The non-transitory program storage device of claim 13, wherein the sending of the application data when the first device is a member of a collection group is performed symmetrically and equivalently across all other devices that are members of the collection group.

15. The non-transitory program storage device of claim 13, wherein the stored set of rules are controlled by the first device.

16. An apparatus comprising:
means for receiving application data from a first application on the first device, wherein the application is designed to automatically send application data pertaining to a first service to the server;
means for determining if the first device is a member of a collection group or a control group;
means for, when the first device is a member of a collection group, sending the application data to one or more other devices that are members of the collection group to allow the other members of the collection group to provide a version of the first service having unfiltered application data; and
means for, when the first device is a member of a control group, sending some, but not all, of the application data to particular one or more other devices that are members of the control group, based on a stored set of rules, to allow the other members of the control group to provide a version of the first service having filtered application data.

17. The apparatus of claim 16, wherein the apparatus is controlled by a service provider.

18. The apparatus of claim 16, wherein the apparatus is part of a home network.
